(19) United States
(12) Patent Application Publication
(10) Pub. No.: US 2016/0362935 A1
(43) Pub. Date: Dec. 15, 2016

(54) LIFT FOR ROLLING LADDER

(71) Applicant: R on I, Inc., Charlotte, NC (US)

(72) Inventor: Gunnar Karl Lofgren, Charlotte, NC (US)

(21) Appl. No.: 14/735,793

(22) Filed: Jun. 10, 2015

(51) Int. Cl. E06C 7/12; E06C 5/02; E06C 1/39

(52) U.S. Cl. CPC E06C 7/12; E06C 1/39; E06C 5/02

(57) ABSTRACT

A lift adapted to be attached to a rolling ladder having a frame including first and second spaced-apart frame members mounted on wheels and between which are attached a series of inclined ladder steps. The lift includes a base on which is mounted a lift motor, a vertically-extending mast positioned on and extending upwardly from the base, and a load-carrying lift platform mounted on the mast and adapted for motor-powered movement of the lift platform and load up and down the mast. At least one laterally-extending attachment member is carried by the mast and adapted to be attached to the first and second spaced-apart frame members for attaching the lift to the rolling ladder. The attachment member is width-adjustable to permit the lift to be attached to rolling ladders of different widths.

### TECHNICAL FIELD AND BACKGROUND OF THE INVENTION

The present invention relates to a lift for a rolling ladder, particularly a lift that is adapted to be easily and quickly retrofitted onto a wide variety of rolling ladders of different designs. Rolling ladders are found in numerous retail, commercial, and industrial facilities where, for example, inventory items are stored above a level that cannot otherwise be reached by an individual standing on a floor-level surface. While commonly referred to as “ladders”, they more closely resemble stairs and are typically provided with hand rails that extend upwardly above the level of the inclined ladder steps. The rolling ladder shown in U.S. Pat. No. 6,283,249 shows a typical rolling ladder that incorporates as part of the design an integrated “lifting tray.”

While rolling ladders with a lift integrated into the design are known, the overwhelming majority of rolling ladders have no such integrated lift capability. This means that an individual may use the hand rails when he or she is not carrying a load, but must traverse the ladder with either one or no hand available to use the hand rail. This defeats the purpose of the hand rails, since the rolling ladder is for the express purpose of allowing a user to reach a height above floor height to remove or place an object such as a large box at the above level height. Thus, the user will most often carry a box up or down the stairs without the benefit of the safety provided by the hand rails.

### SUMMARY OF THE INVENTION

There are a very large number of rolling ladders already in use for which there is presently no effective way to provide improved safety to the ladder users configurations.

Therefore, it is an object of the invention to provide a lift that can be easily, quickly and inexpensively retrofitted onto a wide variety of existing rolling ladders.

It is another object of invention to provide a rolling ladder that incorporates a modular lift that is easily removable and replaceable.

These and other objects and advantages of the invention are achieved by providing a lift adapted to be attached to a rolling ladder of the type having a frame including first and second spaced-apart frame members mounted on wheels and between which are attached a series of inclined ladder steps. The lift includes a base on which is mounted an electric-powered lift motor, a vertically-extending mast positioned on and extending upwardly from the base, and a load-carrying lift platform mounted on the mast and adapted for motor-powered movement of the lift platform and load up and down the mast. At least one laterally-extending attachment member is carried by the mast and adapted to be attached to the first and second spaced-apart frame members for attaching the lift to the rolling ladder. The attachment member is width-adjustable to permit the lift to be attached to rolling ladders of different widths.

According to one embodiment of the invention, the electric-powered lift motor is a rechargeable battery-powered motor.

According to another embodiment of the invention, the attachment member includes first and second cooperating elongate member elements adapted to be length-adjusted relative to each other to permit attachment of the attachment member to the first and second frame members.

According to another embodiment of the invention, the elongate member elements include telescoping tubes having connection elements on respective opposed ends for attachment to respective ones of the first and second frame members.

According to another embodiment of the invention, the lift includes at least one lock for locking the tubes against movement relative to each other.

According to another embodiment of the invention, the attachment member includes first and second stationary tubes positioned in longitudinal alignment with each other, connected together, and secured to the mast. A first width adjustment tube is adapted for being attached by one end to the first frame member with an opposing end positioned in telescoping relation into the first stationary tube. A second width adjustment tube is adapted for being attached by one end to the frame member with an opposing end positioned in telescoping relation into the second stationary tube, whereby the total width of the attachment member permits the lift to be attached to the rolling ladder. At least one lock is provided for locking at least one of the first and second width adjustment tubes in a fixed position in the respective one of the first and second stationary tubes.

According to another embodiment of the invention, the first and second stationary tubes are both provided with a lock that locks the respective first and second width adjustment tube into a fixed position.

According to another embodiment of the invention, the mast is secured to the attachment member at a position above the base to stabilize the mast against lateral movement.

According to another embodiment of the invention, the mast is attached to the rolling ladder only by attachment to the attachment member.

According to another embodiment of the invention, the mast is attached to at least one of the stationary tubes of the attachment member. According to another embodiment of the invention, a rolling ladder is provided that includes a frame having first and second spaced-apart frame members mounted on wheels and between which are attached a series of inclined ladder steps. A lift is attached to the frame proximate a highest ladder step, and includes a base on which is mounted an electric-powered lift motor, a vertically-extending mast positioned on and extending upwardly from the base and a load-carrying lift platform mounted on the mast and adapted for motor-powered movement of the lift platform and load up and down the mast. At least one laterally-extending attachment member is carried by the mast and attached to the first and second spaced-apart frame members. The attachment member is width-adjustable to permit the lift to be attached to rolling ladders of different widths.

According to another embodiment of the invention, the attachment member comprises first and second cooperating elongate member elements length-adjusted relative to each other to permit attachment of the attachment member to the first and second frame members.

According to another embodiment of the invention, a base support is provided for supporting the base at a position spaced above a floor. The base support is adapted to be carried by a side of the base positioned forward of the frame of the rolling ladder.

According to another embodiment of the invention, the base support comprises a wheel. According to another embodiment of the invention, a remote controller is provided for permitting a user to control movement of the lift platform from either a position on or off of the rolling ladder.

According to another embodiment of the invention, the motor includes a radio signal receiver and the remote controller includes a radio signal transmitter for transmitting control signals to the motor to actuate the motor to drive the lift platform in an up or down direction on the mast.

### BRIEF DESCRIPTION OF THE DRAWINGS

Some of the objects of the invention have been set forth above. Other objects and advantages of the invention will appear as the description of the invention proceeds when taken in conjunction with the following drawings, in which:

FIG. 1 is a floor-level perspective view of a lift according to one embodiment of the invention mounted on a conventional rolling ladder;

FIG. 2 is an elevated perspective view of the rolling ladder and mounted lift shown in FIG. 1;

FIG. 3 is a rear, front-facing fragmentary perspective view of the rolling ladder and mounted lift shown in FIG. 1, illustrating the base, lift, mast and width adjustment assembly;

FIG. 4 is a front, rear-facing fragmentary perspective view of the rolling ladder and mounted lift shown in FIG. 1, illustrating the base, lift, mast and width adjustment assembly;

FIG. 5 is an environmental view of the rolling ladder and mounted lift, illustrating a wireless remote control feature; and

FIG. 6 is an environmental view of the rolling ladder and mounted lift.

### DETAILED DESCRIPTION OF A PREFERRED EMBODIMENT AND BEST MODE

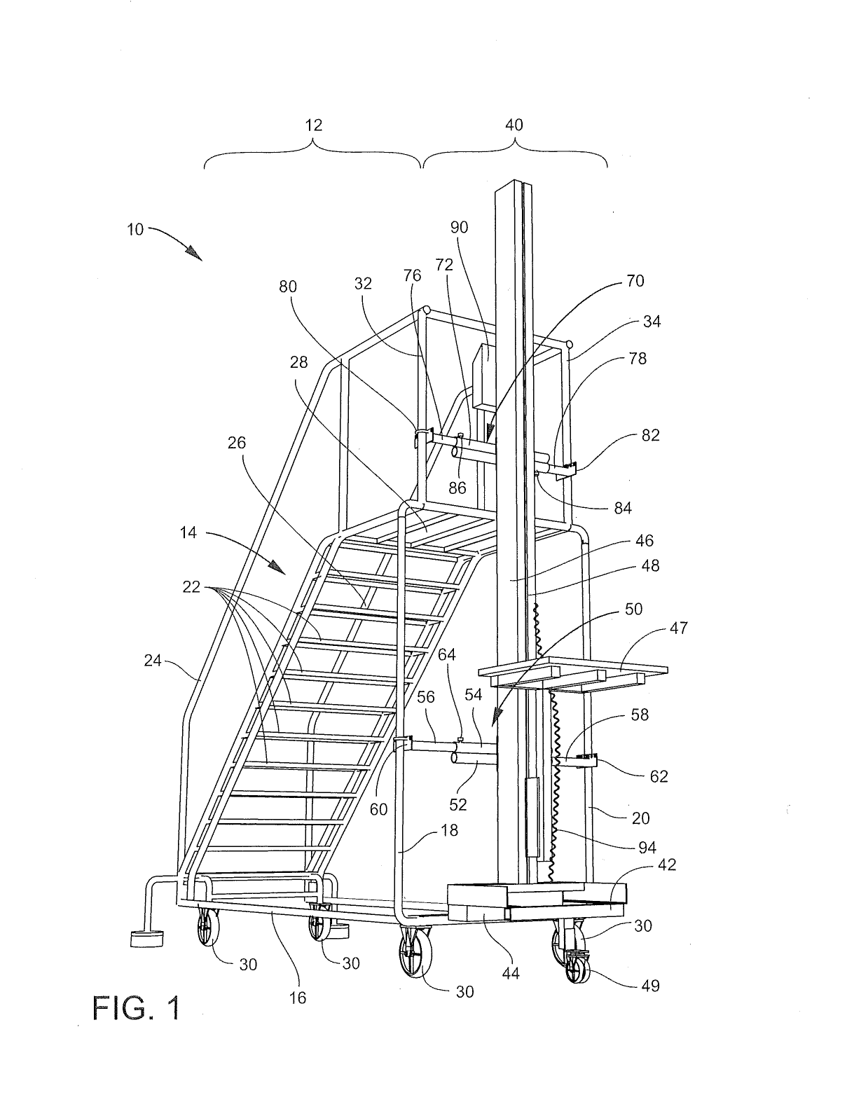

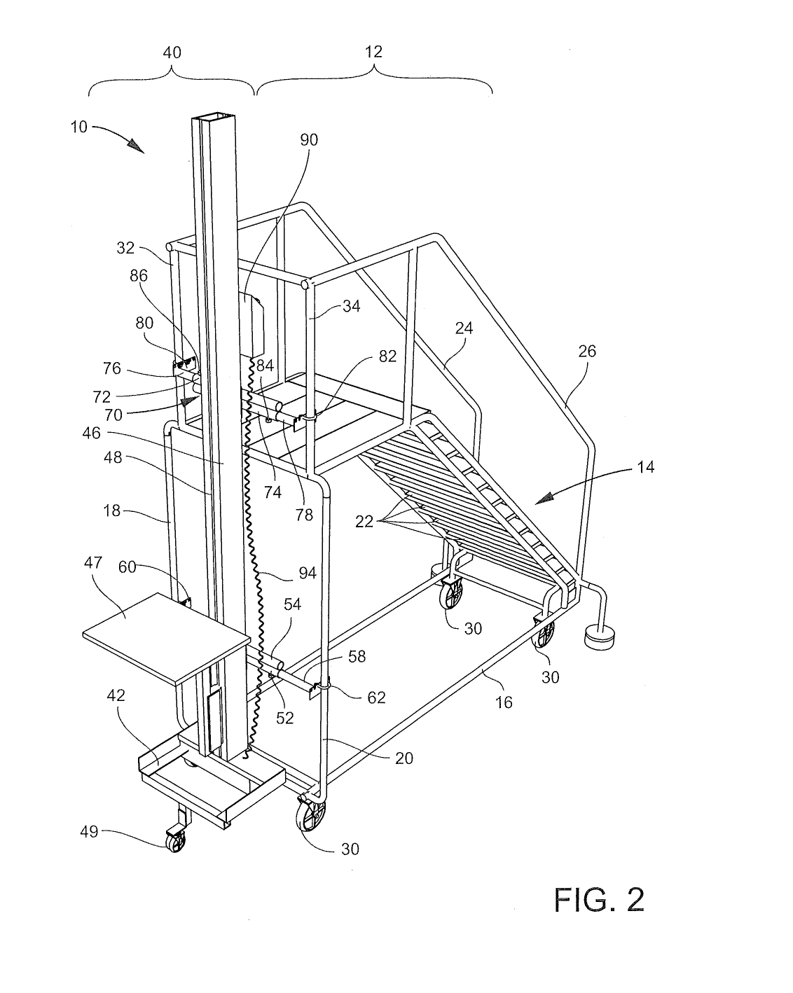

Referring now to the drawings, a rolling ladder of conventional design is shown to which is mounted a lift, collectively referred to as a “rolling ladder/lift assembly” and indicated at reference numeral 10 of FIGS. 1 and 2. The rolling ladder/lift assembly 10 includes a conventional rolling ladder 12 constructed of a frame 14 comprised of a rectangular base frame 16, first and second vertically-extending frame members 18, 20, an inclined series of ladder steps 22, hand rails 24, 26, a ladder platform 28 at the top of the ladder steps 22, and wheels 30 that permit the rolling ladder to be moved as desired. A pair of upright hand rail frame members 32, 34 support the hand rails above the ladder platform 28 and extend upwardly above the frame members 18, 20 of the base frame 16. These ladder components vary somewhat from design to design and from manufacturer to manufacturer but are typical, well-known and are therefore not further described.

A lift 40 portion of the rolling ladder/lift assembly 10 according to the invention is mounted to the front of the ladder 12 by two adjustable connections as described below. The lift 40 includes a base 42 on which is mounted an electric-powered motor 44. The motor 44 is preferably DC-powered and includes a battery and charger. A mast 46 is vertically-mounted on the base 42, with a height determined by need, but which extend 10 feet (3 meters) or more. The mast 46 functions conventionally with a worm gear 43 rotated by the motor 44. A load-carrying lift platform 47 is mounted on the worm gear 43 by a threaded nut 45 through a slot 48 extending along the front of the mast 46, and moves vertically up and down under the control of the motor 44.

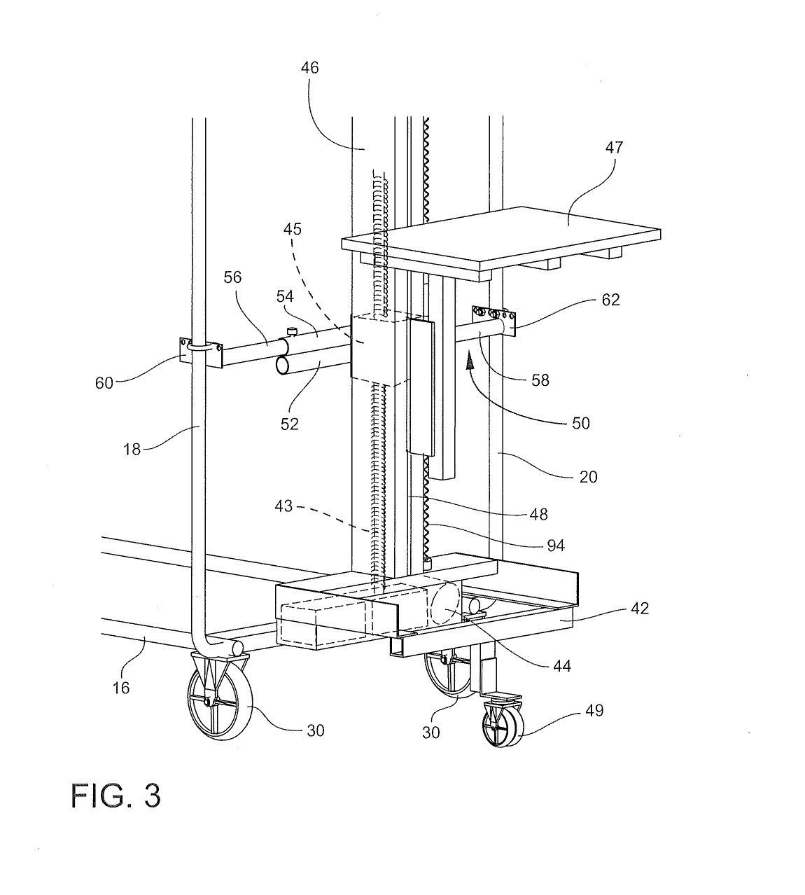

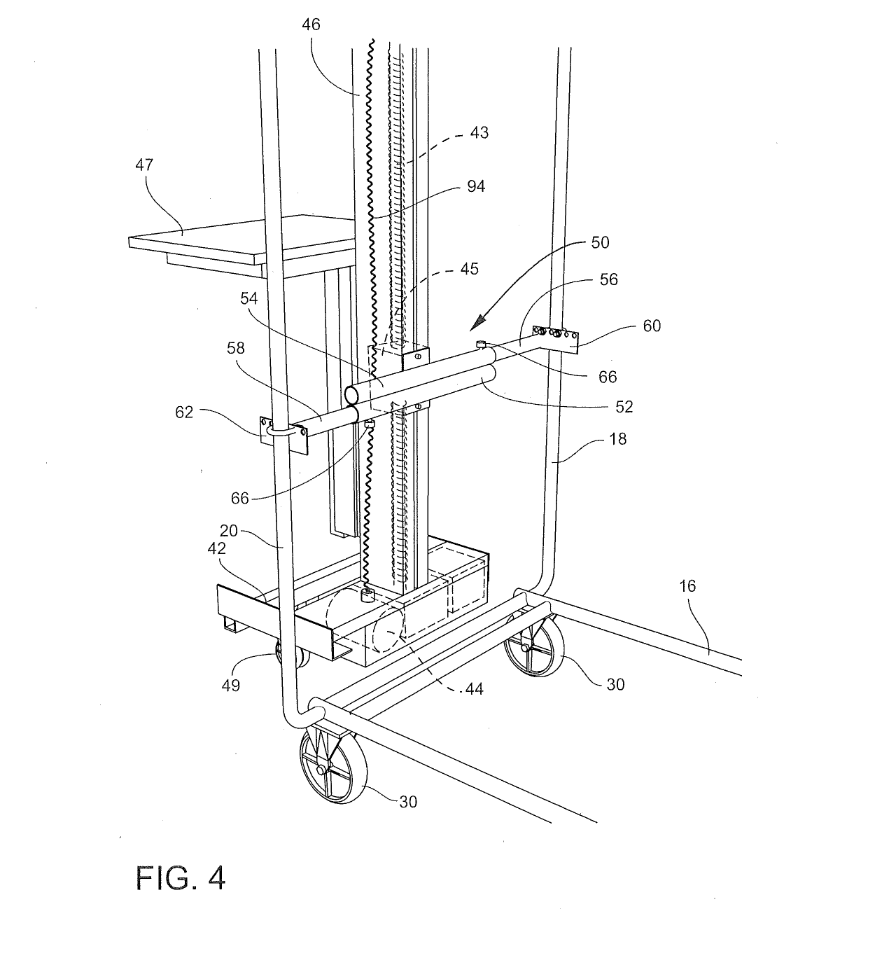

In the particular embodiment shown in the drawings, the lift 40 is connected to the ladder 12 by attachment members 50 and 70 mounted on the frame members 18, 20 of base frame 16 and hand rail frame members 32, 34, respectively. As best shown in FIGS. 3 and 4, the attachment member 50 is length-adjustable to fit the width-wise space between the frame members 18, 20. Stationary tubes 52, 54 are secured to the back of mast 46, as shown. Width adjustment tubes 56, 58 are attached to the frame members 18, 20 by respective U-bolt mounting brackets 60, 62 and extend into the respective stationary tubes 54, 52 to the extent necessary to achieve the necessary total width, and are locking into place by lock bolts 64, 66 that extend through threaded bolt holes in the stationary tubes 54, 52 and bear against the width adjustment tubes 56, 58 to lock them into position.

In the embodiment shown in the drawings, the upper part of the mast 46 is similarly secured to the hand rail frame members 32, 34, respectively of the ladder 12 by the attachment member 70. As best shown in FIGS. 1 and 2, the attachment member 70 is length-adjustable to fit the width-wise space between the hand rail frame members 32, 34. Stationary tubes 72, 74 are secured to the back of mast 46, as shown. Width adjustment tubes 76, 78 are attached to the hand rail frame members 32, 34 by respective U-bolt mounting brackets 80, 82 and extend into the respective stationary tubes 72, 74 to the extent necessary to achieve the necessary total width, and are locking into place by lock bolts 84, 86 that extend through threaded bolt holes in the stationary tubes 84, 82 and bear against the width adjustment tubes 76, 78 to lock them into position.

Note that in the particular ladder 12 to which the lift 40 is attached, the width space between the frame members 18 and 20 is greater than the width between the hand rail frame members 32, 34, yet both width spaces are accommodated by the telescoping adjustment feature described above.

Note also that mast 46 is supported only by the base 42 and its attachment to the attachment members 50 and 70. The attachment members 50 and 70 provide lateral support to the mast 46. It is not necessary to directly attach the mast 46 to any part of the ladder 12. As is best shown in FIG. 4, the base 42 is also not attached directly to the ladder 12, but only by means of the mast 46. The base 42 is supported on the front end by a caster wheel 49.

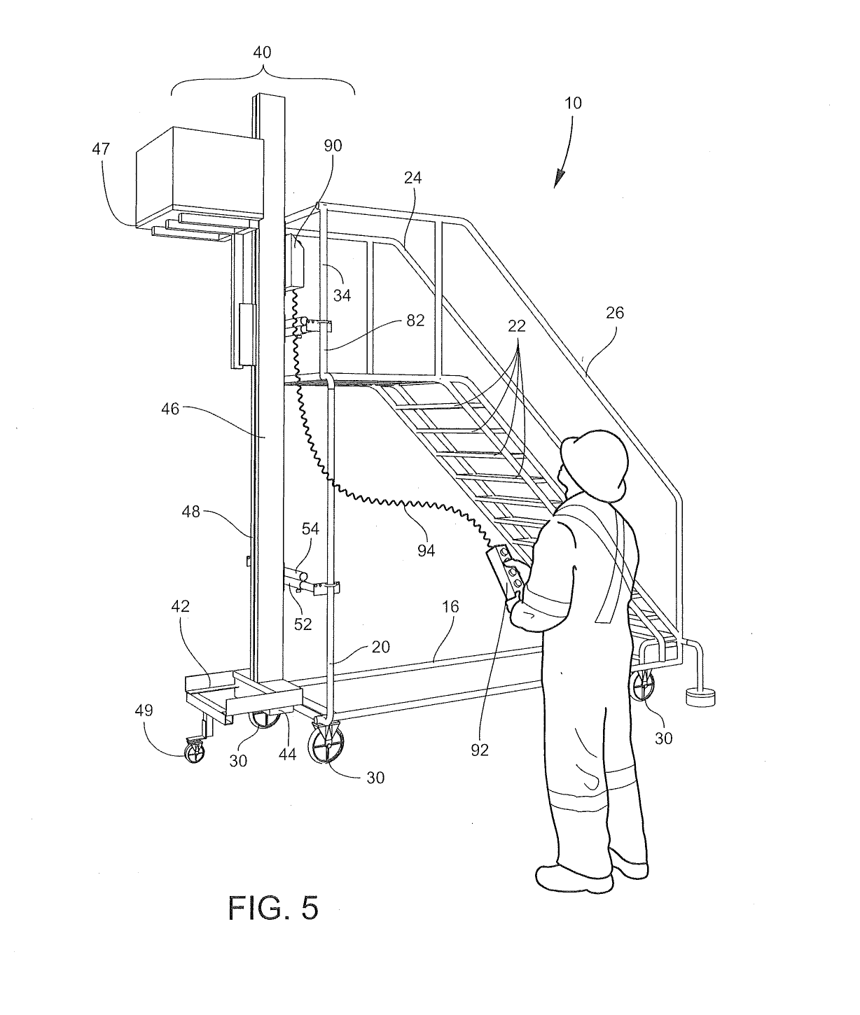

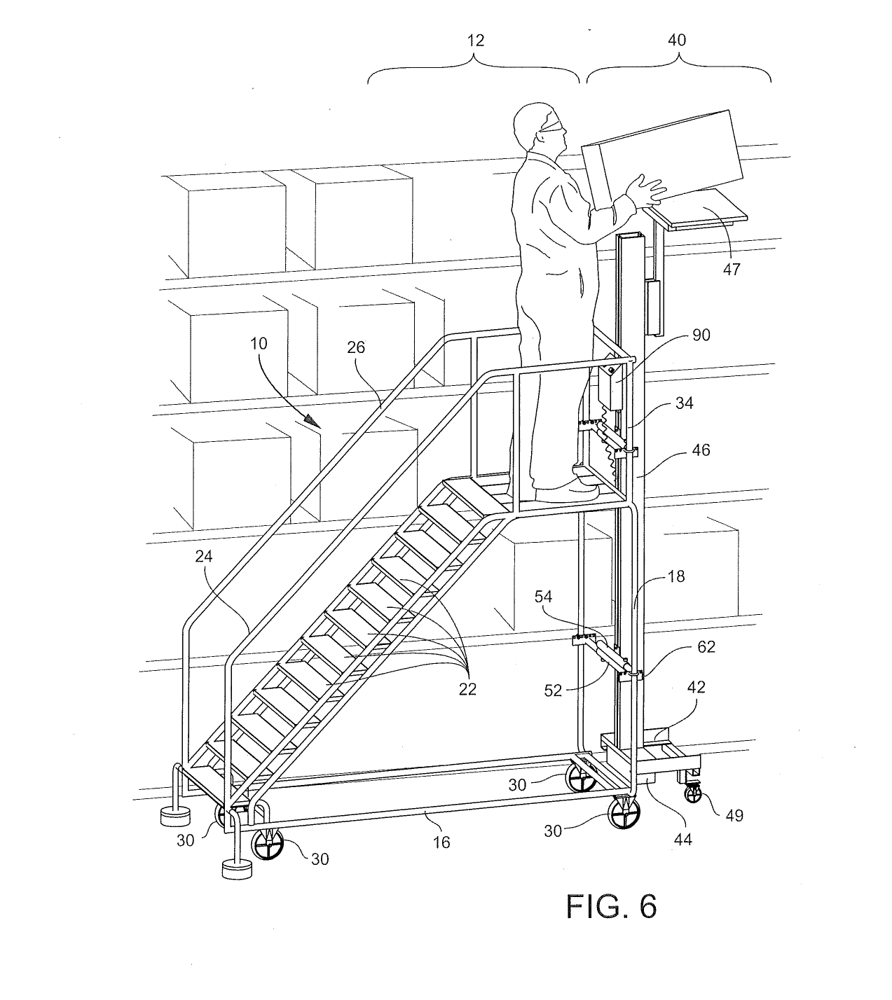

As best shown in FIGS. 1 and 2, the motor 44 is controlled by a control panel 90 mounted on the mast 46 at a position where it can be operated by an operator standing at the top of the ladder 12. See FIG. 6. The lift 40 can also be controlled remotely, see FIG. 5, by an operator standing on a floor near the ladder 10. In this alternative the motor 44 is operated by a remotely-operated handheld control panel 92 connected to the control panel 90 by a cable 94. In a further alternative, the motor 44 includes a radio signal receiver and the remotely operated handheld control panel 92 includes a radio signal transmitter for transmitting control signals to the motor 44 to actuate the motor 44 to drive the lift platform 47 in an up or down direction on the mast 46.

In accordance with one preferred embodiment, the lift 40 has a load capacity of 70 pounds, a lift height of 10 feet (3 meters) or more, a lift speed of 8 inches (20 cm) per second, and will accommodate ladder widths of from 24 inches (61 cm) to 35.5 inches (90 cm). Of course, these values are merely illustrative of values that can be accommodated within the scope of the invention.

A lift for a rolling ladder and a rolling ladder including a lift is described above. Various details of the invention may be changed without departing from its scope. Furthermore, the foregoing description of the preferred embodiment of the invention and the best mode for practicing the invention are provided for the purpose of illustration only and not for the purpose of limitation—the invention being defined by the claims.

What is claimed is:

1. A lift adapted to be attached to a rolling ladder of the type having a frame including first and second spaced-apart frame members mounted on wheels and between which are attached a series of inclined ladder steps, the lift comprising:
(a) a base on which is mounted an electric-powered lift motor;
(b) a vertically-extending mast positioned on and extending upwardly from the base;
(c) a load-carrying lift platform mounted on the mast and adapted for motor-powered movement of the lift platform and load up and down the mast; and
(c) at least one laterally-extending attachment member carried by the mast and adapted to be attached to the first and second spaced-apart frame members for attaching the lift to the rolling ladder, the attachment member being width-adjustable to permit the lift to be attached to rolling ladders of different widths.

2. A lift according to claim 1, wherein the electric-powered lift motor is a rechargeable battery-powered motor.

3. A lift according to claim 1, wherein the attachment member comprises first and second cooperating elongate member elements adapted to be length-adjusted relative to each other to permit attachment of the attachment member to the first and second frame members.

4. A lift according to claim 3, wherein the elongate member elements comprise telescoping tubes having connection elements on respective opposed ends for attachment to respective ones of the first and second frame members.

5. A lift according to claim 4, and including at least one lock for locking the tubes against movement relative to each other.

6. A lift according to claim 3, wherein the attachment member comprises:
(a) first and second stationary tubes positioned in longitudinal alignment with each other, connected together, and secured to the mast;
(b) a first width adjustment tube adapted for being attached by one end to the first frame member with an opposing end positioned in telescoping relation into the first stationary tube;
(c) a second width adjustment tube adapted for being attached by one end to the frame member with an opposing end positioned in telescoping relation into the second stationary tube, whereby the total width of the attachment member permits the lift to be attached to the rolling ladder; and
(d) at least one lock for locking at least one of the first and second width adjustment tubes in a fixed position in the respective one of the first and second stationary tubes.

7. A lift according to claim 6, wherein the first and second stationary tubes are both provided with a lock that locks the respective first and second width adjustment tube into a fixed position.

8. A lift according to claim 4, wherein the mast is secured to the attachment member at a position above the base to stabilize the mast against lateral movement.

9. A lift according to claim 8, wherein the mast is attached to the rolling ladder only by attachment to the attachment member.

10. A lift according to claim 6, wherein the mast is attached to at least one of the stationary tubes of the attachment member.

11. A lift adapted to be attached to a rolling ladder of the type having first and second spaced-apart frame members mounted on wheels and between which are attached a series of inclined ladder steps, the lift comprising:
(a) a base on which is mounted an electric-powered lift motor;
(b) a vertically-extending mast positioned on and extending upwardly from the base;
(c) a load-carrying lift platform mounted on the mast and adapted for motor-powered movement of the lift platform and carried load up and down the mast;
(d) at least one attachment member for attaching the lift to the rolling ladder; and
(d) a base support for supporting the base at a position spaced above a floor, the base support adapted to be carried by a side of the base positioned forward of the rolling ladder when the lift is attached to the rolling ladder.

12. A lift according to claim 11, wherein the base support comprises a wheel.

13. A lift according to claim 12, wherein the wheel is a caster wheel assembly mounted to an underside of the base.

14. A lift adapted to be attached to a rolling ladder of the type having a frame including first and second spaced-apart frame members mounted on wheels and between which are attached a series of inclined ladder steps, the lift comprising:
(a) a base on which is mounted an electrically-powered lift motor;
(b) a vertically-extending mast positioned on and extending upwardly from the base;
(c) a load-carrying lift platform mounted on the mast and adapted for motor-powered movement of the lift platform and load up and down the mast; and
(c) at least one laterally-extending attachment member carried by the mast; and
(d) a remote controller for permitting a user to control movement of the lift platform from either a position on or off of the rolling ladder.

15. A lift according to claim 14, wherein the motor includes a radio signal receiver and the remote controller includes a radio signal transmitter for transmitting control signals to the motor to actuate the motor to drive the lift platform in an up or down direction on the mast.

16. A rolling ladder, comprising:
(a) a frame including first and second spaced-apart frame members mounted on wheels and between which are attached a series of inclined ladder steps;
(b) a lift attached to the frame proximate a highest ladder step, and comprising:
(I) a base on which is mounted an electric-powered lift motor;
(ii) a vertically-extending mast positioned on and extending upwardly from the base;
(iii) a load-carrying lift platform mounted on the mast and adapted for motor-powered movement of the lift platform and load up and down the mast; and
(iv) at least one laterally-extending attachment member carried by the mast and attached to the first and second spaced-apart frame members, the attachment member being width-adjustable to permit the lift to be attached to rolling ladders of different widths.

17. A rolling ladder according to claim 16, wherein the attachment member comprises first and second cooperating elongate member elements length-adjusted relative to each other to permit attachment of the attachment member to the first and second frame members.

18. A rolling ladder according to claim 17, wherein the elongate member elements comprise telescoping tubes having connection elements on respective opposed ends and attached to respective ones of the first and second frame members.

19. A rolling ladder according to claim 18, and including at least one lock for locking the tubes against movement relative to each other.

20. A rolling ladder according to claim 19, wherein the attachment member comprises:
(a) first and second stationary tubes positioned in longitudinal alignment with each other, connected together, and secured to the mast;
(b) a first width adjustment tube attached by one end to the first frame member with an opposing end positioned in telescoping relation into the first stationary tube;
(c) a second width adjustment tube attached by one end to the frame member with an opposing end positioned in telescoping relation into the second stationary tube; and
(d) at least one lock for locking at least one of the first and second width adjustment tubes in a fixed position in the respective one of the first and second stationary tubes.

21. A rolling ladder according to claim 16, and including a base support for supporting the base at a position spaced above a floor, the base support adapted to be carried by a side of the base positioned forward of the rolling ladder when the lift is attached to the rolling ladder.

22. A rolling ladder according to claim 21, wherein the base support comprises a wheel.

23. A rolling ladder according to claim 16, and including a remote controller for permitting a user to control movement of the lift platform from either a position on or off of the rolling ladder.

24. A rolling ladder according to claim 23, wherein the motor includes a radio signal receiver and the remote controller includes a radio signal transmitter for transmitting control signals to the motor to actuate the motor to drive the lift platform in an up or down direction on the mast.
